(19) United States
(12) Patent Application Publication
(10) Pub. No.: US 2023/0162038 A1
(43) Pub. Date: May 25, 2023

(54) USING TRANSFER LEARNING TO REDUCE DISCREPANCY BETWEEN TRAINING AND INFERENCE FOR A MACHINE LEARNING MODEL

(71) Applicant: Maplebear Inc. (dba Instacart), San Francisco, CA (US)

(72) Inventors: Peng Qi, Menlo Park, CA (US); Zhenbang Chen, Jersey City, NJ (US)

(21) Appl. No.: 17/534,184

(22) Filed: Nov. 23, 2021

(51) Int. Cl. G06N 3/08; G06N 3/04; G06Q 30/02

(52) U.S. Cl. CPC G06N 3/084; G06N 3/04; G06Q 30/0202

(57) ABSTRACT

An online system uses a trained model predicting likelihoods of a user performing a specific interaction with items to order or to rank items for display to the user. The online system trains the model using interactions by users with items displayed by the online system. However, selection, popularity, and position from display of the items affects the model during training. To improve the model, the online system further trains the model using additional training data obtained from displaying items to users in different orders. The further training is done on a limited portion of the model, such as a limited number of layers of the model, to improve the model performance while reducing an amount of additional data to acquire to further train the model.

### BACKGROUND

This disclosure relates generally to training a machine learning model, and more specifically to training the machine learning model with training data and to training a subset of the machine learning model using additional training data.

In current online concierge systems, shoppers (or “pickers”) fulfill orders at a physical warehouse, such as a retailer, on behalf of users as part of an online shopping concierge service. An online concierge system provides an interface to a user identifying items offered by a physical warehouse and receives selections of one or more items for an order from the user. In current online concierge systems, the shoppers may be sent to various warehouses with instructions to fulfill orders for items, and the shoppers then find the items included in the user order in a warehouse.

Many online concierge systems maintain a large inventory of items. For example, an online concierge system communicating with multiple warehouses may maintain a catalog of tens or hundreds of thousand items, if not more. To simplify creation of orders by users, many online concierge systems, or other online systems, train one or more machine learning models to predict likelihoods of a user performing one or more interactions with an item. Such machine learning models determine a probability of a user performing an interaction, such as purchasing, an item based on embeddings of the user and of the item.

Conventional online concierge systems update these machine learning models from content displayed to users and interactions by the users with the displayed content. While this allows the machine learning models to reflect current interactions by users with displayed content, the content displayed to the user may have one or more biases introduced from how content is displayed to users that affect the user’s interactions. For example, items that have higher popularity with users are more frequently presented to users, increasing the frequency of interactions with the more frequently presented items because of their increased visibility. As another example, users may be influenced by a position in an interface where an item is presented, increasing an amount of interaction with certain items because of their position in an interface when displayed to users. While an online concierge system, or other online system, may use alternative or additional training data that display items to users in random orders, or otherwise in orders independent of likelihoods of users interacting with the items to offset the above-identified biases, obtaining sufficient alternative or additional training data to offset the above-identified biases is likely to decrease overall user interaction with an online concierge system by increasing an amount of inputs from users to select items for inclusion in orders.

### SUMMARY

The online concierge system generates item embeddings for items offered by one or more warehouses and user embeddings for users of the online concierge system. Example attributes of an item from which an item embedding is generated include words or phrases provided by users to identify the item, one or more categories associated with the item, popularity of the item at a warehouse, or any other suitable attributes. Example characteristics of a user from which a user embedding is generated include products purchased by the user, categories associated with products purchased by a user, preferences of the user, restrictions of the user, warehouses from which the user purchased items, and any other suitable characteristics.

Additionally, the online concierge system trains and maintains a model that generates a probability of a user performing a specific interaction with an item, such as purchasing the item. The model receives as input an item embedding for an item generated by the item model and a user embedding for a user generated by the user model and outputs a probability of the user performing the specific interaction with the item. To train the model, the online concierge system obtains one or more training datasets from stored transactions by one or more users with the online concierge system. Alternatively, an item embedding or a user embedding is extracted from a layer of the model when the model is applied to inputs, with a user embedding or an item embedding generated during training of the model; in such an embodiment, the model is trained by application to training data comprising examples that are random vectors for a user and for an item, with a corresponding user embedding and an item embedding extracted from a layer of the model during training, with backpropagation of one or more error terms, as further described below, through the model updating the user embedding and the item embedding. For example, the online concierge system identifies purchases made by users within a specific time interval. In some embodiments, the online concierge system identifies purchases within a specific time interval and made by users who have previously made at least a threshold number of purchases via the online concierge system. A training dataset obtained includes information identifying a user making a purchase, items included in the purchase, a warehouse from which the purchase was made, and temporal information (e.g., a date, a time) of the purchase. Other training datasets include information describing different interactions with items by users, such as including one or more items in an order, selecting content items corresponding to one or more items, requesting additional information about one or more items, or any other suitable interactions. A training dataset includes information identifying users and one or more specific interactions performed by the user after items were displayed to the user by the online concierge system. Hence, a training dataset includes information describing specific interactions performed by users after the online concierge system displayed items to the users.

The online concierge system generates labeled training data for training the model. To generate training data for the model, the online concierge system associates a label indicating whether the user performed the specific interaction with an item with a combination of attributes of the item and characteristics of the user. For example, the training data includes examples each comprising a combination of attributes of the item and characteristics of the user to which a label was applied indicating whether the specific interaction was or was not performed by the user with the item. Hence, the training data includes an item embedding for an item, a user embedding for a user, and a label indicating whether the user performed the specific interaction with the item (e.g., a label indicating whether the item was purchased or was not purchased by the user).

The online concierge system applies the model to the labeled training data, generating a probability of a user performing the specific interaction with an item based on the user embedding for the user and the item embedding for the item. The online concierge system compares the generated probability of the user performing the specific interaction with the item to the label applied to the combination of the user embedding of the user and the item embedding of the item in an example of the training data. In various embodiments, additional information is associated with the user embedding of the user and the item embedding of the item and the label; examples of additional information include a time, a warehouse, a description of the item, and any other suitable information. If the comparison indicates the probability generated by the model differs from the label applied to the combination of the user embedding for the user and the item embedding of the item (e.g., the generated probability is below a threshold for performing the specific interaction the item when the label indicates the specific interaction with the item was performed or the generated probability is above a threshold for performing the specific interaction with the item when the label indicates the specific interaction was not performed), the online concierge system modifies one or more parameters of the model using any suitable supervised learning method. For example, the online concierge system backpropagates the one or more error terms from the label applied to an example of the training data and the output of the model. One or more parameters of the model are modified through any suitable technique from the backpropagation of the one or more error terms through the layers of the network. The error term may be generated through any suitable loss function, or combination of loss functions, in various embodiments. The online concierge system may iteratively modify the model a specified number of times or until one or more criteria are satisfied using any suitable supervised learning method. For example, the online concierge system iteratively modifies the model until a loss function based on a difference between a label applied to an example of the training data and a probability generated by the model satisfies one or more conditions.

Because the model is trained from specific interactions performed by users from display of items to the users by the online concierge system based on probabilities output by the model, the training data may be affected by one or more biases from how the items were displayed. For example, the training data may be affected by a popularity bias for items having higher popularity. As higher popularity items are frequently presented to users, a frequency of interactions with the more frequently presented items is increased, resulting in increased representation of the higher popularity items in the training data. Further, position bias may influence interactions with items by various users by a frequency of user interaction with items being affected by a position or a location in an interface where items are displayed to users. For example, certain users may more frequently interact with items that are displayed in particular positions of an interface or may less frequently interact with items that are displayed in the particular positions of the interface. While training the model based on interactions performed by users with items allows the model to reflect interactions patterns by users, popularity bias, position bias, or other biases introduced by how the online concierge system selects and displays items decreases accuracy of the model.

To offset biases introduced by selection and display of items, the online concierge system obtains exploration training data. The exploration training data is obtained by display of items in a random order to users and capturing information describing the one or more specific interactions by the users after display of the items in the random order. Hence, the exploration data removes effects of how the items are ordered and positions in which the items are displayed by the online concierge system, allowing the online concierge system to more accurately evaluate attributes of an item in influencing user interaction independent of prior display of the items or locations in the interface where items are displayed. The exploration training data includes examples that each comprise a combination of attributes of an item and characteristics of a user, with a label applied to each example indicating whether the user performed the specific interaction with the item. For example, the training data includes examples each comprising a combination of attributes of the item and characteristics of the user to which a label was applied indicating whether the specific interaction was or was not performed by the user with the item.

However, the random display of items for obtaining the exploration training data increases an amount of inputs by users to identify items relevant to a user and to subsequently interact with a relevant item. Such increased amount of input to identify relevant items can decrease subsequent interaction with the online concierge system by users. Hence, the online concierge system obtains the exploration training data by displaying items to users in the random order during a specific percentage of access to the online concierge system by users. For example, the online concierge system displays the items in a random order to users during 5% of access to the online concierge system by users, allowing the online concierge system to obtain the exploration training data without discouraging users from subsequently interacting with the online concierge system.

To modify the trained model using the exploration training data while efficiently allocating computational resources and time for training the model, the online concierge system identifies a portion of the model to train and freezes values for the other portions of the model. For example, the online concierge system identifies layers of the model within a threshold distance of the output of the model and freezes values for layers of the model that are greater than the threshold distance of the output of the model. In other embodiments, the online concierge system uses any suitable criteria to identify the portion of the model. In other embodiments, values of the embeddings are frozen rather than layers of the model.

The online concierge system applies the model to examples of the exploration training data. As further described above, application of the model to an example of the exploration training data generates a probability of a user performing the specific interaction with an item based on the user embedding for the user and the item embedding for the item. The online concierge system compares the generated probability of the user performing the specific interaction with the item to the label applied to the combination of the user embedding of the user and the item embedding of the item in the example of the exploration training data. If the comparison indicates the probability generated by the model differs from the label applied to the combination of the user embedding for the user and the item embedding of the item (e.g., the generated probability is below a threshold for performing the specific interaction the item when the label indicates the specific interaction with the item was performed or the generated probability is above a threshold for performing the specific interaction with the item when the label indicates the specific interaction was not performed), the online concierge system modifies one or more parameters of the identified portion of the model using any suitable supervised learning method, while leaving parameters of other portions of the model unchanged. For example, the online concierge system backpropagates the one or more error terms from the label applied to an example of the training data and the output of the model through the identified portion of the model. One or more parameters of the portion of the model, such as weights connecting layers included in the portion of the model, are modified through any suitable technique from the backpropagation of the one or more error terms through the layers of the model included in the identified portion of the model, but not through other portions of the model. The error term may be generated through any suitable loss function, or combination of loss functions, in various embodiments. The online concierge system may iteratively modify the identified portion of the model a specified number of times or until one or more criteria are satisfied using any suitable supervised learning method. For example, the online concierge system iteratively modifies the identified portion of the model until a loss function based on a difference between a label applied to an example of the training data and a probability generated by the model satisfies one or more conditions. The online concierge system subsequently stores the model for subsequent application to combinations of item embeddings and user embeddings.

### BRIEF DESCRIPTION OF THE DRAWINGS

FIG. 1 illustrates an environment of an online shopping concierge service, according to one embodiment.

FIG. 2 is a diagram of an online shopping concierge system, according to one embodiment.

FIG. 3A is a diagram of a customer mobile application (CMA), according to one embodiment.

FIG. 3B is a diagram of a shopper mobile application (SMA), according to one embodiment.

FIG. 4 is an example model that generates a probability of a user performing an interaction after an item is displayed to the user, according to one embodiment.

FIG. 5 is a flowchart of a method for an online concierge system training a model to determine a probability of a user performing an interaction with an item, according to one embodiment.

FIG. 6 is a process flow diagram of training a model to determine a probability of a user performing an interaction with an item.

The figures depict embodiments of the present disclosure for purposes of illustration only. One skilled in the art will readily recognize from the following description that alternative embodiments of the structures and methods illustrated herein may be employed without departing from the principles, or benefits touted, of the disclosure described herein.

### DETAILED DESCRIPTION

### System Overview

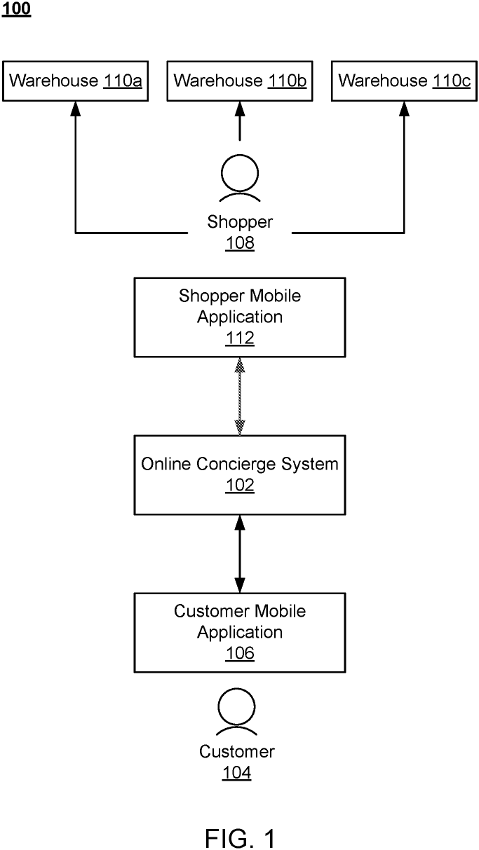

FIG. 1 illustrates an environment 100 of an online platform, according to one embodiment. The figures use like reference numerals to identify like elements. A letter after a reference numeral, such as “110a,” indicates that the text refers specifically to the element having that particular reference numeral. A reference numeral in the text without a following letter, such as “110,” refers to any or all of the elements in the figures bearing that reference numeral. For example, “110” in the text refers to reference numerals “110a” and/or “110b” in the figures.

The environment 100 includes an online concierge system 102. The system 102 is configured to receive orders from one or more users 104 (only one is shown for the sake of simplicity). An order specifies a list of goods (items or products) to be delivered to the user 104. The order also specifies the location to which the goods are to be delivered, and a time window during which the goods should be delivered. In some embodiments, the order specifies one or more retailers from which the selected items should be purchased. The user may use a customer mobile application (CMA) 106 to place the order; the CMA 106 is configured to communicate with the online concierge system 102.

The online concierge system 102 is configured to transmit orders received from users 104 to one or more shoppers 108. A shopper 108 may be a contractor, employee, other person (or entity), robot, or other autonomous device enabled to fulfill orders received by the online concierge system 102. The shopper 108 travels between a warehouse and a delivery location (e.g., the user’s home or office). A shopper 108 may travel by car, truck, bicycle, scooter, foot, or other mode of transportation. In some embodiments, the delivery may be partially or fully automated, e.g., using a self-driving car. The environment 100 also includes three warehouses 110a, 110b, and 110c (only three are shown for the sake of simplicity; the environment could include hundreds of warehouses). The warehouses 110 may be physical retailers, such as grocery stores, discount stores, department stores, etc., or non-public warehouses storing items that can be collected and delivered to users. Each shopper 108 fulfills an order received from the online concierge system 102 at one or more warehouses 110, delivers the order to the user 104, or performs both fulfillment and delivery. In one embodiment, shoppers 108 make use of a shopper mobile application 112 which is configured to interact with the online concierge system 102.

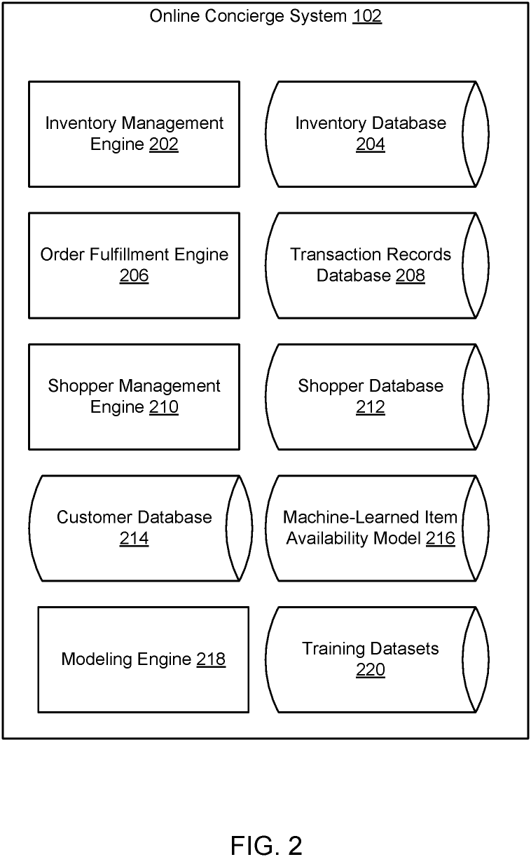

FIG. 2 is a diagram of an online concierge system 102, according to one embodiment. The online concierge system 102 includes an inventory management engine 202, which interacts with inventory systems associated with each warehouse 110. In one embodiment, the inventory management engine 202 requests and receives inventory information maintained by the warehouse 110. The inventory of each warehouse 110 is unique and may change over time. The inventory management engine 202 monitors changes in inventory for each participating warehouse 110. The inventory management engine 202 is also configured to store inventory records in an inventory database 204. The inventory database 204 may store information in separate records — one for each participating warehouse 110 — or may consolidate or combine inventory information into a unified record. Inventory information includes both qualitative and qualitative information about items, including size, color, weight, SKU, serial number, and so on. In one embodiment, the inventory database 204 also stores purchasing rules associated with each item, if they exist. For example, age-restricted items such as alcohol and tobacco are flagged accordingly in the inventory database 204. Additional inventory information useful for predicting the availability of items may also be stored in the inventory database 204. For example, for each item-warehouse combination (a particular item at a particular warehouse), the inventory database 204 may store a time that the item was last found, a time that the item was last not found (a shopper looked for the item but could not find it), the rate at which the item is found, and the popularity of the item.

Inventory information provided by the inventory management engine 202 may supplement the training datasets 220. Inventory information provided by the inventory management engine 202 may not necessarily include information about the outcome of picking a delivery order associated with the item, whereas the data within the training datasets 220 is structured to include an outcome of picking a delivery order (e.g., if the item in an order was picked or not picked).

The online concierge system 102 also includes an order fulfillment engine 206 which is configured to synthesize and display an ordering interface to each user 104 (for example, via the customer mobile application 106). The order fulfillment engine 206 is also configured to access the inventory database 204 in order to determine which products are available at which warehouse 110. The order fulfillment engine 206 may supplement the product availability information from the inventory database 204 with an item availability predicted by the machine-learned item availability model 216. The order fulfillment engine 206 determines a sale price for each item ordered by a user 104. Prices set by the order fulfillment engine 206 may or may not be identical to in-store prices determined by retailers (which is the price that users 104 and shoppers 108 would pay at the retail warehouses). The order fulfillment engine 206 also facilitates transactions associated with each order. In one embodiment, the order fulfillment engine 206 charges a payment instrument associated with a user 104 when he/she places an order. The order fulfillment engine 206 may transmit payment information to an external payment gateway or payment processor. The order fulfillment engine 206 stores payment and transactional information associated with each order in a transaction records database 208.

In some embodiments, the order fulfillment engine 206 also shares order details with warehouses 110. For example, after successful fulfillment of an order, the order fulfillment engine 206 may transmit a summary of the order to the appropriate warehouses 110. The summary may indicate the items purchased, the total value of the items, and in some cases, an identity of the shopper 108 and user 104 associated with the transaction. In one embodiment, the order fulfillment engine 206 pushes transaction and/or order details asynchronously to retailer systems. This may be accomplished via use of webhooks, which enable programmatic or system-driven transmission of information between web applications. In another embodiment, retailer systems may be configured to periodically poll the order fulfillment engine 206, which provides detail of all orders which have been processed since the last request.

The order fulfillment engine 206 may interact with a shopper management engine 210, which manages communication with and utilization of shoppers 108. In one embodiment, the shopper management engine 210 receives a new order from the order fulfillment engine 206. The shopper management engine 210 identifies the appropriate warehouse to fulfill the order based on one or more parameters, such as a probability of item availability determined by a machine-learned item availability model 216, the contents of the order, the inventory of the warehouses, and the proximity to the delivery location. The shopper management engine 210 then identifies one or more appropriate shoppers 108 to fulfill the order based on one or more parameters, such as the shoppers’ proximity to the appropriate warehouse 110 (and/or to the user 104), his/her familiarity level with that particular warehouse 110, and so on. Additionally, the shopper management engine 210 accesses a shopper database 212 which stores information describing each shopper 108, such as his/her name, gender, rating, previous shopping history, and so on.

As part of fulfilling an order, the order fulfillment engine 206 and/or shopper management engine 210 may access a user database 214 which stores information describing each user. This information could include each user’s name, address, gender, shopping preferences, favorite items, stored payment instruments, and so on.

### Machine Learning Models

The online concierge system 102 further includes a machine-learned item availability model 216, a modeling engine 218, and training datasets 220. The modeling engine 218 uses the training datasets 220 to generate the machine-learned item availability model 216. The machine-learned item availability model 216 can learn from the training datasets 220, rather than follow only explicitly programmed instructions. The inventory management engine 202, order fulfillment engine 206, and/or shopper management engine 210 can use the machine-learned item availability model 216 to determine a probability that an item is available at a warehouse 110. The machine-learned item availability model 216 may be used to predict item availability for items being displayed to or selected by a user or included in received delivery orders. A single machine-learned item availability model 216 is used to predict the availability of any number of items.

The machine-learned item availability model 216 can be configured to receive as inputs information about an item, the warehouse for picking the item, and the time for picking the item. The machine-learned item availability model 216 may be adapted to receive any information that the modeling engine 218 identifies as indicators of item availability. At minimum, the machine-learned item availability model 216 receives information about an item-warehouse pair, such as an item in a delivery order and a warehouse at which the order could be fulfilled. Items stored in the inventory database 204 may be identified by item identifiers. As described above, various characteristics, some of which are specific to the warehouse (e.g., a time that the item was last found in the warehouse, a time that the item was last not found in the warehouse, the rate at which the item is found, the popularity of the item) may be stored for each item in the inventory database 204. Similarly, each warehouse may be identified by a warehouse identifier and stored in a warehouse database along with information about the warehouse. A particular item at a particular warehouse may be identified using an item identifier and a warehouse identifier. In other embodiments, the item identifier refers to a particular item at a particular warehouse, so that the same item at two different warehouses is associated with two different identifiers. For convenience, both of these options to identify an item at a warehouse are referred to herein as an “item-warehouse pair.” Based on the identifier(s), the online concierge system 102 can extract information about the item and/or warehouse from the inventory database 204 and/or warehouse database and provide this extracted information as inputs to the item availability model 216.

The machine-learned item availability model 216 contains a set of functions generated by the modeling engine 218 from the training datasets 220 that relate the item, warehouse, and timing information, and/or any other relevant inputs, to the probability that the item is available at a warehouse. Thus, for a given item-warehouse pair, the machine-learned item availability model 216 outputs a probability that the item is available at the warehouse. The machine-learned item availability model 216 constructs the relationship between the input item-warehouse pair, timing, and/or any other inputs and the availability probability (also referred to as “availability”) that is generic enough to apply to any number of different item-warehouse pairs. In some embodiments, the probability output by the machine-learned item availability model 216 includes a confidence score. The confidence score may be the error or uncertainty score of the output availability probability and may be calculated using any standard statistical error measurement. In some examples, the confidence score is based in part on whether the item-warehouse pair availability prediction was accurate for previous delivery orders (e.g., if the item was predicted to be available at the warehouse and not found by the shopper or predicted to be unavailable but found by the shopper). In some examples, the confidence score is based in part on the age of the data for the item, e.g., if availability information has been received within the past hour, or the past day. The set of functions of the item availability model 216 may be updated and adapted following retraining with new training datasets 220. The machine-learned item availability model 216 may be any machine learning model, such as a neural network, boosted tree, gradient boosted tree or random forest model. In some examples, the machine-learned item availability model 216 is generated from XGBoost algorithm.

The item probability generated by the machine-learned item availability model 216 may be used to determine instructions delivered to the user 104 and/or shopper 108, as described in further detail below.

The training datasets 220 relate a variety of different factors to known item availability from the outcomes of previous delivery orders (e.g. if an item was previously found or previously unavailable). The training datasets 220 include the items included in previous delivery orders, whether the items in the previous delivery orders were picked, warehouses associated with the previous delivery orders, and a variety of characteristics associated with each of the items (which may be obtained from the inventory database 204). Each piece of data in the training datasets 220 includes the outcome of a previous delivery order (e.g., if the item was picked or not). The item characteristics may be determined by the machine-learned item availability model 216 to be statistically significant factors predictive of the item’s availability. For different items, the item characteristics that are predictors of availability may be different. For example, an item type factor might be the best predictor of availability for dairy items, whereas a time of day may be the best predictive factor of availability for vegetables. For each item, the machine-learned item availability model 216 may weigh these factors differently, where the weights are a result of a “learning” or training process on the training datasets 220. The training datasets 220 are very large datasets taken across a wide cross section of warehouses, shoppers, items, warehouses, delivery orders, times and item characteristics. The training datasets 220 are large enough to provide a mapping from an item in an order to a probability that the item is available at a warehouse. In addition to previous delivery orders, the training datasets 220 may be supplemented by inventory information provided by the inventory management engine 202. In some examples, the training datasets 220 are historic delivery order information used to train the machine-learned item availability model 216, whereas the inventory information stored in the inventory database 204 include factors input into the machine-learned item availability model 216 to determine an item availability for an item in a newly received delivery order. In some examples, the modeling engine 218 may evaluate the training datasets 220 to compare a single item’s availability across multiple warehouses to determine if an item is chronically unavailable. This may indicate that an item is no longer manufactured. The modeling engine 218 may query a warehouse 110 through the inventory management engine 202 for updated item information on these identified items.

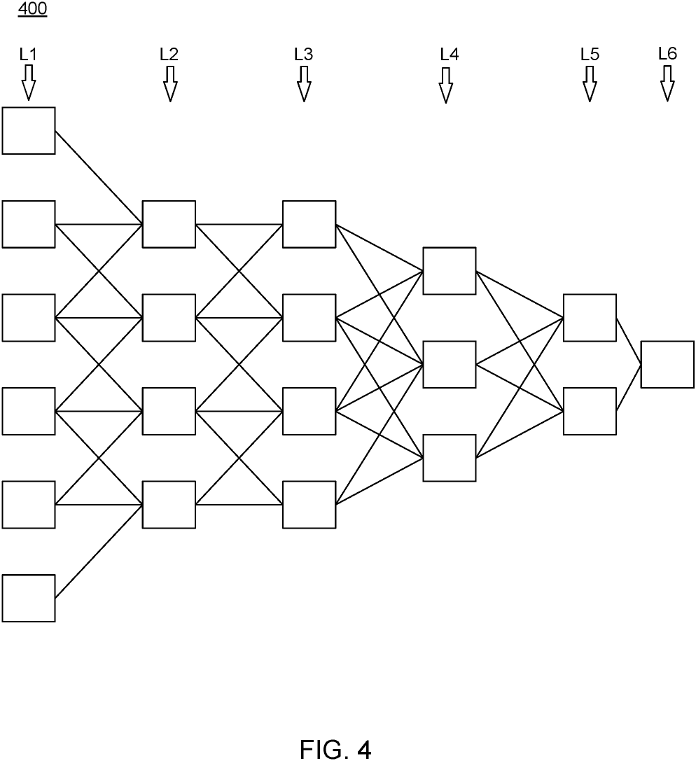

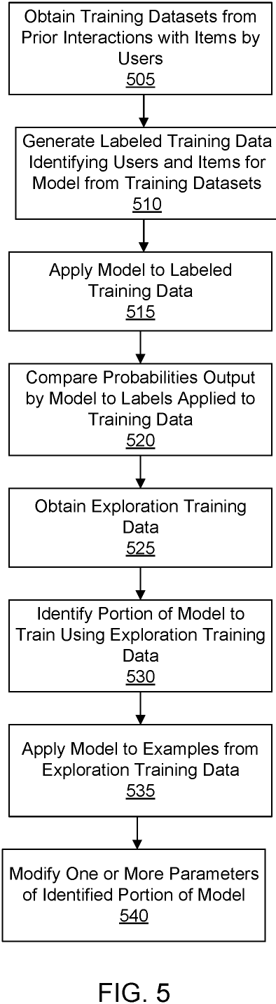

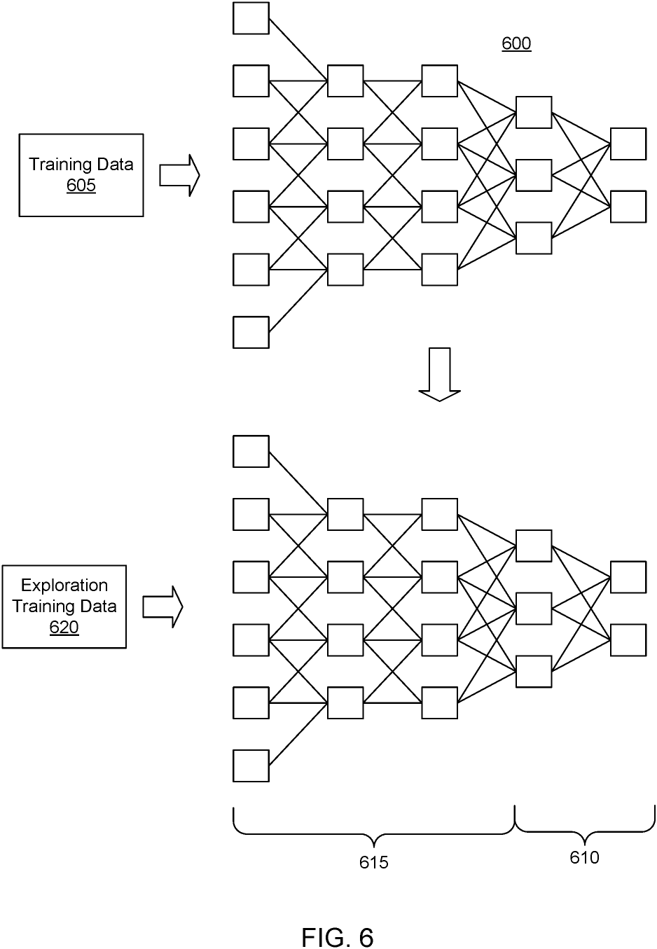

Additionally, the modeling engine 218 maintains a trained model, further described below in conjunction with FIGS. 4-6. In some embodiments, the trained model includes a user model and an item model that generate a user embedding for a user and an item embedding for an item, respectively. The user model generates the user embedding for the user based on prior purchases by the user, preferences of the user, and any other suitable characteristics of the user. The item model generates the item embedding for the item based on different words or phrases received by the online concierge system 102 as terms from users in interactions where the user selected the item, one or more categories associated with the item, popularity of the item at a warehouse 110, or any other suitable attributes of an item. From user embedding for the user and an item embedding for an item, the trained model determines a probability of the user performing a specific interaction with the item, as further described below in conjunction with FIG. 5. In other embodiments, the model obtains a user embedding for a user and an item embedding for an item from any suitable source and determines the probability of the user performing the specific interaction with the item from the user embedding and the item embedding, as further described below in conjunction with FIG. 5. Examples of specific interactions with an item include: purchasing the item, including the item in an order, selecting a content item corresponding to the item, saving the item, requesting additional information about the item, or any other suitable interaction. In various embodiments, the user embedding for a user and the item embedding for an item have an equal number of dimensions, and the model generates the probability of the user performing the specific interaction with the item based on a dot product or other measure of similarity between the user embedding for the user and the item embedding for the item. As further described below in conjunction with FIG. 5, the modeling engine 218 trains the model based on interactions with items by users. As interactions by users with items may be influenced by orders in which items are displayed to users based on the output of the model, the modeling engine 218 identifies a portion of the model that is a subset of layers of the model and further modifies parameters of the portion of the model without modifying parameters of other portions of the model from exploration training data generated from interactions by users with items displayed to the users in a random order, as further described below in conjunction with FIGS. 5 and 6.

### Machine Learning Factors

The training datasets 220 include a time associated with previous delivery orders. In some embodiments, the training datasets 220 include a time of day at which each previous delivery order was placed. Time of day may impact item availability, since during high-volume shopping times, items may become unavailable that are otherwise regularly stocked by warehouses. In addition, availability may be affected by restocking schedules, e.g., if a warehouse mainly restocks at night, item availability at the warehouse will tend to decrease over the course of the day. Additionally, or alternatively, the training datasets 220 include a day of the week previous delivery orders were placed. The day of the week may impact item availability, since popular shopping days may have reduced inventory of items or restocking shipments may be received on particular days. In some embodiments, training datasets 220 include a time interval since an item was previously picked in a previous delivery order. If an item has recently been picked at a warehouse, this may increase the probability that it is still available. If there has been a long-time interval since an item has been picked, this may indicate that the probability that it is available for subsequent orders is low or uncertain. In some embodiments, training datasets 220 include a time interval since an item was not found in a previous delivery order. If there has been a short time interval since an item was not found, this may indicate that there is a low probability that the item is available in subsequent delivery orders. And conversely, if there has been a long-time interval since an item was not found, this may indicate that the item may have been restocked and is available for subsequent delivery orders. In some examples, training datasets 220 may also include a rate at which an item is typically found by a shopper at a warehouse, a number of days since inventory information about the item was last received from the inventory management engine 202, a number of times an item was not found in a previous week, or any number of additional rate or time information. The relationships between this time information and item availability are determined by the modeling engine 218 training a machine learning model with the training datasets 220, producing the machine-learned item availability model 216.

The training datasets 220 include item characteristics. In some examples, the item characteristics include a department associated with the item. For example, if the item is yogurt, it is associated with the dairy department. The department may be the bakery, beverage, nonfood and pharmacy, produce and floral, deli, prepared foods, meat, seafood, dairy, the meat department, or dairy department, or any other categorization of items used by the warehouse. The department associated with an item may affect item availability, since different departments have different item turnover rates and inventory levels. In some examples, the item characteristics include an aisle of the warehouse associated with the item. The aisle of the warehouse may affect item availability, since different aisles of a warehouse may be more frequently re-stocked than others. Additionally, or alternatively, the item characteristics include an item popularity score. The item popularity score for an item may be proportional to the number of delivery orders received that include the item. An alternative or additional item popularity score may be provided by a retailer through the inventory management engine 202. In some examples, the item characteristics include a product type associated with the item. For example, if the item is a particular brand of a product, then the product type will be a generic description of the product type, such as “milk” or “eggs.” The product type may affect the item availability, since certain product types may have a higher turnover and re-stocking rate than others or may have larger inventories in the warehouses. In some examples, the item characteristics may include a number of times a shopper was instructed to keep looking for the item after he or she was initially unable to find the item, a total number of delivery orders received for the item, whether or not the product is organic, vegan, gluten free, or any other characteristics associated with an item. The relationships between item characteristics and item availability are determined by the modeling engine 218 training a machine learning model with the training datasets 220, producing the machine-learned item availability model 216.

The training datasets 220 may include additional item characteristics that affect the item availability and can therefore be used to build the machine-learned item availability model 216 relating the delivery order for an item to its predicted availability. The training datasets 220 may be periodically updated with recent previous delivery orders. The training datasets 220 may be updated with item availability information provided directly from shoppers 108. Following updating of the training datasets 220, a modeling engine 218 may retrain a model with the updated training datasets 220 and produce a new machine-learned item availability model 216.

### Customer Mobile Application

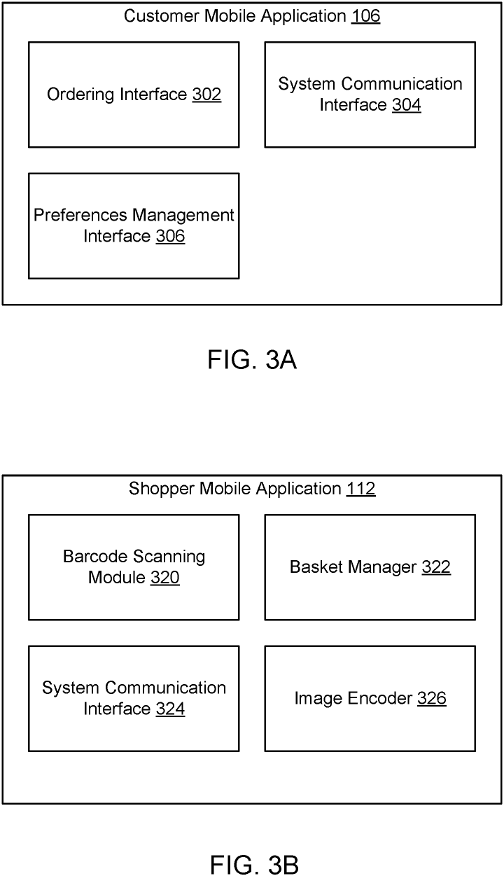

FIG. 3A is a diagram of the customer mobile application (CMA) 106, according to one embodiment. The CMA 106 includes an ordering interface 302, which provides an interactive interface with which the user 104 can browse through and select products and place an order. The CMA 106 also includes a system communication interface 304 which, among other functions, receives inventory information from the online shopping concierge system 102 and transmits order information to the system 102. The CMA 106 also includes a preferences management interface 306 which allows the user 104 to manage basic information associated with his/her account, such as his/her home address and payment instruments. The preferences management interface 306 may also allow the user to manage other details such as his/her favorite or preferred warehouses 110, preferred delivery times, special instructions for delivery, and so on.

### Shopper Mobile Application

FIG. 3B is a diagram of the shopper mobile application (SMA) 112, according to one embodiment. The SMA 112 includes a barcode scanning module 320 which allows a shopper 108 to scan an item at a warehouse 110 (such as a can of soup on the shelf at a grocery store). The barcode scanning module 320 may also include an interface which allows the shopper 108 to manually enter information describing an item (such as its serial number, SKU, quantity and/or weight) if a barcode is not available to be scanned. SMA 112 also includes a basket manager 322 which maintains a running record of items collected by the shopper 108 for purchase at a warehouse 110. This running record of items is commonly known as a “basket”. In one embodiment, the barcode scanning module 320 transmits information describing each item (such as its cost, quantity, weight, etc.) to the basket manager 322, which updates its basket accordingly. The SMA 112 also includes a system communication interface 324 which interacts with the online shopping concierge system 102. For example, the system communication interface 324 receives an order from system 102 and transmits the contents of a basket of items to system 102. The SMA 112 also includes an image encoder 326 which encodes the contents of a basket into an image. For example, the image encoder 326 may encode a basket of goods (with an identification of each item) into a QR code which can then be scanned by an employee of the warehouse 110 at check-out.

### Example Model for Predicting a Likelihood of a User Performing a Specific Interaction

FIG. 4 shows an example model 400 generating a probability of a user performing an interaction after a content item or an item is displayed to the user. The model 400 shown in FIG. 4, comprises a plurality of layers (e.g., layers L1 through L6), with each of the layers including one or more nodes. Each node has an input and an output and is associated with a set of instructions corresponding to the computation performed by the node. The set of instructions corresponding to the nodes of the network comprising the model 400 may be executed by one or more computer processors.

Each connection between nodes in the model 400 may be represented by a weight (e.g., numerical parameter determined through a training process). In some embodiments, the connection between two nodes in the model 400 is a network characteristic. The weight of the connection may represent the strength of the connection. In some embodiments, connections between a node of one level in the model 400 are limited to connections between the node in the level of the model 400 and one or more nodes in another level that is adjacent to the level including the node. In some embodiments, network characteristics include the weights of the connection between nodes of the neural network. The network characteristics may be any values or parameters associated with connections of nodes of the neural network.

A first layer of the model 400 (e.g., layer L1 in FIG. 4) may be referred to as an input layer, while a last layer (e.g., layer L6 in FIG. .4) may be referred to as an output layer. The remaining layers (layers L2, L3, L4, L5) of the model 400 are referred to as hidden layers. Nodes of the input layer are correspondingly referred to as input nodes; nodes of the output layer are referred to as output nodes, and nodes of the hidden layers are referred to as hidden nodes. Nodes of a layer provide input to another layer and may receive input from another layer. For example, nodes of each hidden layer (L2, L3, L4, L5) are associated with two layers (a previous layer and a next layer). A hidden layer (L2, L3, L4, L5) receives an output of a previous layer as input and provides an output generated by the hidden layer as an input to a next layer. For example, nodes of hidden layer L3 receive input from the previous layer L2 and provide input to the next layer L4, while nodes of hidden layer L4 provide input to the next layer L5.

The layers of the model 400 are configured to identify one or more embeddings of a user identified to the model 400. For example, an output of the last hidden layer of the model 400 (e.g., the last layer before the output layer, illustrated in FIG. 4 as layer L5) indicates one or more embeddings of the user. An embedding of the user may be expressed as a set of vectors (e.g., a 256-bit vector) indicating features of the identified user to form a feature vector for the identified user. In other embodiments, the output layer of the model 400 may output one or more scores associated with an embedding. For example, an output score corresponds to a probability that the user will perform a specific interaction after a content item is displayed to the user. The model 400 may correspond to a specific interaction, and the online concierge system 102 may maintain multiple models 400 that each correspond to a specific interaction, allowing the online concierge system 102 to determine probabilities of a user performing different specific interactions using different models 400.

In some embodiments, the weights between different nodes in the model 400 may be updated using machine learning techniques. The model 400 may receive training data identifying users with a label applied to each identified user that indicates whether the user performed a specific interaction after a content item was displayed to the user. In some embodiments, the training data comprises a set of feature vectors corresponding to a specific number or specific percentage of users of the online concierge system 102; each feature vector of the training set data associated with a corresponding label identifying users with a label applied to each identified user. An output probability of the user from the training set performing the specific interaction by the model 400 is compared to the label applied to the user of the training set to generate an error term. For example, the error term is determined by a loss function applied to the output probability of the user from the training set performing the specific interaction by the model 400 and to the label applied to the user of the training set to generate an error term. The online concierge system 102 backpropagates the error term through layers of a network comprising the model 400 until one or more loss functions satisfy one or more criteria. In some embodiments, the online concierge system uses gradient descent or any other suitable process to minimize the one or more error terms in various embodiments.

In response to the one or more loss functions satisfying the one or more criteria and the online concierge system 102 stopping the backpropagation of the one or more error terms, the online concierge system 102 stores the set of parameters for the layers of the model 400. For example, the online concierge system stores the weights of connections between nodes in the model 400.

### Training a Model to Determine a Probability of a User Performing an Interaction With an Item

FIG. 5 is a flowchart of a method for an online concierge system 102 training a model to determine a probability of a user performing an interaction with an item. In various embodiments, the method includes different or additional steps than those described in conjunction with FIG. 5. Further, in some embodiments, the steps of the method may be performed in different orders than the order described in conjunction with FIG. 5. For purposes of illustration, FIG. 5 describes the online concierge system 102 performing the method, in other embodiments, other online systems providing content items for display to users may perform the steps of the method.

The online concierge system 102 generates item embeddings for items offered by one or more warehouses 110 and user embeddings for users of the online concierge system 102. An “embedding” refers to descriptive data associated with an item or a user that indicates attributes or characteristics of the item or the user. Example attributes of an item from which an item embedding is generated include words or phrases provided by users to identify the item, one or more categories associated with the item, popularity of the item at a warehouse 110, or any other suitable attributes. Example characteristics of a user from which a user embedding is generated include products purchased by the user, categories associated with products purchased by a user, preferences of the user, restrictions of the user, warehouses 110 from which the user purchased items, and any other suitable characteristics. In some embodiments, an item embedding or a user embedding comprises a feature vector having multiple dimensions, with each dimension including a value derived from one or more attributes of the item or characteristics of the user. The online concierge system 102 may generate the item embeddings and the user embeddings from an item model and a user model maintained by the online concierge system 102, which comprise machine learning models in various embodiments.

Additionally, the online concierge system 102 trains and maintains a model that generates a probability of a user performing a specific interaction with an item, such as purchasing the item. The model receives as input an item embedding for an item generated by the item model and a user embedding for a user generated by the user model and outputs a probability of the user performing the specific interaction with the item. To train the model, the modeling engine 218 of the online concierge system 102 obtains 505 training datasets from stored transactions by one or more users with the online concierge system 102, such as data from the transaction records database 208. For example, the modeling engine 218 identifies purchases made by users within a specific time interval from the transaction records database 208. In some embodiments, the modeling engine 218 identifies purchases within a specific time interval and made by users who have previously made at least a threshold number of purchases via the online concierge system 102. A training dataset obtained 505 from the transaction records database 208 includes information identifying a user making a purchase, items included in the purchase, a warehouse 110 from which the purchase was made, and temporal information (e.g., a date, a time) of the purchase. Other training datasets retrieved from the transaction records database 208 include information describing different interactions with items by users, such as including one or more items in an order, selecting content items corresponding to one or more items, requesting additional information about one or more items, or any other suitable interactions. A training dataset retrieved from the transaction records database 208 includes information identifying users and one or more specific interactions performed by the user after items were displayed to the user by the online concierge system 102. Hence, a training dataset from the transaction records database 208 includes information describing specific interactions performed by users after the online concierge system 102 displayed items to the users. Alternatively, an item embedding or a user embedding is extracted from a layer of the model when the model is applied to inputs, with a user embedding or an item embedding generated during training of the model; in such an embodiment, the model is trained by application to training data comprising examples that are random vectors for a user and for an item, with a corresponding user embedding and an item embedding extracted from a layer of the model during training, with backpropagation of one or more error terms, as further described below, through the model updating the user embedding and the item embedding.

From information in a training dataset identifying purchases (or other interactions), the modeling engine 218 selects a purchase (or another interaction) and identifies a user who performed the purchase, items included in the purchase, and a warehouse 110 from which the items were purchased. The modeling engine 218 uses information about the selected purchase to generate 510 labeled training data for training the model. To generate 510 training data for the model, the modeling engine 218 associates a label indicating whether the user performed the specific interaction with an item with a combination of attributes of the item and characteristics of the user. For example, the training data includes examples each comprising a combination of attributes of the item and characteristics of the user to which a label was applied indicating whether the specific interaction was or was not performed by the user with the item. While this allows the modeling engine 218 to generate 510 labeled data for items for which users performed the specific interaction (e.g., items that were purchased), to generate 510 labeled data for items for which the specific interaction was not performed (e.g., items that were not purchased) in the training dataset, the modeling engine 218 samples items offered by the warehouse 110 from which items in for which the specific interaction was performed to which the specific interaction was not performed (e.g., other items offered by a warehouse 110 from which an order including an item was received that were not included in the order). In some embodiments, the modeling engine 218 retrieves an inventory of items offered by the warehouse 110 from which the user performed the specific interaction (e.g., from an order including an item was received) and randomly selects items offered by the warehouse 110 that for which the specific interaction was not performed (e.g., items that were not included in the purchase) and labels characteristics of the user and attributes of the randomly selected items as not having the specific interaction performed by the user. Alternatively, the modeling engine 218 determines a popularity distribution of items previously purchased by users from the warehouse 110 (or for which a user previously performed the specific interaction) from which the selected purchase was made and selects additional items that were not included in the selected purchase (or for which the user did not perform the specific interaction) based on the popularity distribution of previously purchased items (or items for which the specific interaction was previously performed) and labels combinations of attributes of the selected additional item and characteristics of the user as not purchased (or for which the specific interaction was not performed). When generating 510 labeled data, the modeling engine 218 generates a specified ratio of items labeled with the specific interaction being performed (e.g., as purchased) to items labeled with the specific interaction not being performed (e.g., as not purchased) in some embodiments. For example, the labeled data includes a ratio of three items labeled as not purchased to one item labeled as purchased, although the modeling engine 218 may use different ratios in different embodiments.

Additionally, the modeling engine 218 identifies users who performed the specific interaction (e.g., made the purchases) and retrieves characteristics of the identified users. For an identified user, the modeling engine 218 identifies an item embedding for each item included in the purchase or for which the user performed the specific interaction, an embedding corresponding to search terms the online concierge system 102 received from the user, preferences of the user, a length of time the user has used the online concierge system 102, information describing warehouses 110 from which the user previously made purchases, and may identify other information maintained for the user or for purchases made by the user via the online concierge system 102. In some embodiments, the modeling engine 218 additionally identifies embeddings corresponding to words or phrases the online concierge system 102 received from the user when the order was identifying items for the purchase. In some embodiments, for the identified user, the modeling engine 218 retrieves additional purchases previously made by the user or additional transactions where the user performed the specific interaction with an item from the transaction records database 208 and averages item embeddings for items included in purchase previously made by the user or item embeddings for items for which the user performed the specific interaction, resulting in an embedding representing a purchase history of the user. Hence, the training data includes an item embedding for an item, a user embedding for a user, and a label indicating whether the user performed the specific interaction with the item (e.g., a label indicating whether the item was purchased or was not purchased by the user).

The modeling engine 218 applies 515 the model to the labeled training data, generating a probability of a user performing the specific interaction with an item based on the user embedding for the user and the item embedding for the item. The modeling engine 218 compares 520 the generated probability of the user performing the specific interaction with the item to the label applied to the combination of the user embedding of the user and the item embedding of the item in an example of the training data. In various embodiments, additional information is associated with the user embedding of the user and the item embedding of the item and the label; examples of additional information include a time, a warehouse, a description of the item, and any other suitable information. If the comparison indicates the probability generated by the model differs from the label applied to the combination of the user embedding for the user and the item embedding of the item (e.g., the generated probability is below a threshold for performing the specific interaction the item when the label indicates the specific interaction with the item was performed or the generated probability is above a threshold for performing the specific interaction with the item when the label indicates the specific interaction was not performed), the modeling engine 218 modifies one or more parameters of the model using any suitable supervised learning method. For example, the modeling engine 218 backpropagates the one or more error terms from the label applied to an example of the training data and the output of the model. One or more parameters of the model are modified through any suitable technique from the backpropagation of the one or more error terms through the layers of the network. The error term may be generated through any suitable loss function, or combination of loss functions, in various embodiments. The modeling engine 218 may iteratively modify the model a specified number of times or until one or more criteria are satisfied using any suitable supervised learning method. For example, the modeling engine 218 iteratively modifies the model until a loss function based on a difference between a label applied to an example of the training data and a probability generated by the model satisfies one or more conditions.

Because the model is trained from specific interactions performed by users from display of items to the users by the online concierge system 102 and the items are displayed in an order based on probabilities of the users performing the specific interaction with the items determined from the model, the training data may be affected by one or more biases from how the items were displayed. For example, the training data may be affected by a popularity bias for items having higher popularity. As higher popularity items are frequently presented to users, a frequency of interactions with the more frequently presented items is increased, resulting in increased representation of the higher popularity items in the training data. Further, position bias may influence interactions with items by various users by a frequency of user interaction with items being affected by a position or a location in an interface where items are displayed to users. For example, certain users may more frequently interact with items that are displayed in particular positions of an interface or may less frequently interact with items that are displayed in the particular positions of the interface. While training the model based on interactions performed by users with items allows the model to reflect interactions patterns by users, popularity bias, position bias, or other biases introduced by how the online concierge system 102 selects and displays items decreases accuracy of the model.

To offset biases introduced by selection and display of items, the online concierge system 102 obtains 525 exploration training data. The exploration training data is obtained 525 by displaying items in a random order to users and capturing information describing the one or more specific interactions by the users after display of the items in the random order. Hence, the exploration data removes effects of how the items are ordered and positions in which the items are displayed by the online concierge system 102, allowing the online concierge system 102 to more accurately evaluate attributes of an item in influencing user interaction independent of prior display of the items or locations in the interface where items are displayed. The exploration training data includes examples that each comprise a combination of attributes of an item and characteristics of a user, with a label applied to each example indicating whether the user performed the specific interaction with the item. For example, the training data includes examples each comprising a combination of attributes of the item and characteristics of the user to which a label was applied indicating whether the specific interaction was or was not performed by the user with the item.

However, the random display of items for obtaining 525 the exploration training data increases an amount of inputs by users to identify items relevant to a user and to subsequently interact with a relevant item. Such increased amount of input to identify relevant items can decrease subsequent interaction with the online concierge system 102 by users. Hence, the online concierge system 102 obtains 525 the exploration training data by displaying items to users in the random order during a specific percentage of access to the online concierge system 102 by users. For example, the online concierge system 102 displays the items in a random order to users during 5% of accesses to the online concierge system 102 by users, allowing the online concierge system 102 to obtain 525 the exploration training data without discouraging users from subsequently interacting with the online concierge system 102.

To modify the trained model using the exploration training data while efficiently allocating computational resources and time for training the model, the online concierge system 102 identifies 530 a portion of the model to train and freezes values for the other portions of the model. For example, the online concierge system 102 identifies 530 layers of the model within a threshold distance of the output of the model and freezes values for layers of the model that are greater than the threshold distance of the output of the model. In other embodiments, the online concierge system 102 users any suitable criteria to identify 530 the portion of the model. In other embodiments, values of the embeddings are frozen rather than layers of the model

The online concierge system 102, such as the modeling engine 218 of the online concierge system 102, applies 535 the model to examples of the exploration training data. As further described above, application of the model to an example of the exploration training data generates a probability of a user performing the specific interaction with an item based on the user embedding for the user and the item embedding for the item. The modeling engine 218 compares the generated probability of the user performing the specific interaction with the item to the label applied to the combination of the user embedding of the user and the item embedding of the item of the example of the exploration data. If the comparison indicates the probability generated by the model differs from the label applied to the combination of the user embedding for the user and the item embedding of the item (e.g., the generated probability is below a threshold for performing the specific interaction the item when the label indicates the specific interaction with the item was performed or the generated probability is above a threshold for performing the specific interaction with the item when the label indicates the specific interaction was not performed), the modeling engine 218 modifies 540 one or more parameters of the identified portion of the model using any suitable supervised learning method, while leaving parameters of other portions of the model unchanged. For example, the modeling engine 218 backpropagates the one or more error terms from the label applied to an example of the training data and the output of the model through the identified portion of the model. One or more parameters of the portion of the model, such as weights connecting layers included in the portion of the model, are modified 540 through any suitable technique from the backpropagation of the one or more error terms through the layers of the model included in the identified portion of the model, but not through other portions of the model. The error term may be generated through any suitable loss function, or combination of loss functions, in various embodiments. The modeling engine 218 may iteratively modify 540 the identified portion of the model a specified number of times or until one or more criteria are satisfied using any suitable supervised learning method. For example, the modeling engine 218 iteratively modifies 540 the identified portion of the model until a loss function based on a difference between a label applied to an example of the training data and a probability generated by the model satisfies one or more conditions. The online concierge system 102 subsequently stores the model for subsequent application to combinations of item embeddings and user embeddings.

FIG. 6 is a process flow diagram of training a model to determine a probability of a user performing an interaction with an item. In the example of FIG. 6, the model 600 includes multiple layers, as further described above in conjunction with FIG. 4. As further described above in conjunction with FIG. 5, the online concierge system 102 obtains a set of training data 605 from prior presentation of items to users and interactions by the users with the presented items, or after presentation of items to the users. As the model 600 is used to order or to rank items for display to users, the information from which the training data 605 is obtained is affected by one or more biases introduced from orders in which the items are displayed to users, as further described above in conjunction with FIG. 5. The training data 605 includes multiple examples that each comprise a combination of a user embedding and an item embedding, with a label applied to each example indicating whether the user corresponding to the user embedding performed a specific interaction with an item corresponding to the item embedding. As further described above in conjunction with FIG. 6, the online concierge system 102 applies the model 600 to examples of the training data 605 and modifies one or more parameters of the model by backpropagating an error term generated by a loss function applied to an output probability of the model 600 comprising a predicted likelihood of the user of the example performing the specific interaction with the item of the example and the label applied to the example through the model 600.

To offset the biases in the training data 605 from ranking or ordering of the items when displayed to users, the online concierge system 102 identifies a portion 610 of the model 600, as further described above in conjunction with FIG. 5. For example, the portion 610 of the model 600 comprises a subset of layers of the model, such as layers within a specific distance of an output layer of the model. Hence, the online concierge system 102 differentiates between the portion 610 of the model 600 and the remaining portion 615 of the model, with different layers included in the portion 610 and in the remaining portion 615. Additionally, the online concierge system 102 obtains exploration training data 620 from display of items to users in random orders and interactions by users with the items when displayed in a random order. The random display of items to users offsets effects of an order in which items are displayed to a user based on the model 600 on interactions by the user with items. The exploration training data 620 includes multiple examples that each comprise a combination of a user embedding and an item embedding, with a label applied to each example indicating whether the user corresponding to the user embedding performed a specific interaction with an item corresponding to the item embedding.

To conserve computational resources and computational time when using the exploration training data 620, the online concierge system 102 fixes parameters in the remaining portion 615 of the model 600 and applies the model 600 to examples of the exploration training data 620. From application of the model 600 to an example of the exploration training data 620, the online concierge system 102 modifies one or more parameters of the portion 610 of the model 600 by backpropagating an error term generated by a loss function applied to an output probability of the model 600 comprising a predicted likelihood of the user of the example performing the specific interaction with the item of the example and the label applied to the example through the portion 610 of the model 600. The backpropagation of the error term through the portion 610 of the model 600 modifies parameters of layers within the portion 610 of the model but does not modify parameters of layers within the remaining portion 615 of the model. This allows the model 600 to be refined based on the exploration training data 620 to increase accuracy of the model in determining predicted likelihoods of a user performing a specific interaction with an item by compensating for potential biases in the training data 605 introduced from orders in which items are displayed to the user.

### Additional Considerations

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium, which includes any type of tangible media suitable for storing electronic instructions and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
obtaining training data including a plurality of examples of items and of users from interactions by users with items displayed to the users in orders based on likelihoods of a user performing a specific interaction with an item generated from a model, an example of the training data including a combination of a user embedding of the user and an item embedding of the item to which a label indicating whether the user performed the specific interaction with the item is applied;
training the model by applying the model to each example of the training data and backpropagating one or more error terms obtained from one or more loss functions through layers of the model, an error term based on a difference between a predicted likelihood of the user performing the specific interaction with the item and a label applied to an example of the training data including the user and the item;
obtaining exploration training data including a plurality of exploration examples of items and of users from interactions by users with items displayed to the users in random orders an exploration example of the exploration training data including a combination of the user embedding of the user and the item embedding of the item to which a label indicating whether the user performed the specific interaction with the item is applied;
identifying a portion of the model comprising a subset of layers comprising the model;
training the model by applying the model to each exploration example of the exploration training data and backpropagating one or more error terms obtained from one or more loss functions through layers of the portion of the model while freezing layers not included in the portion of the model, the error term based on a difference between the predicted likelihood of the user performing the specific interaction with the item and a label applied to an exploration example of the exploration training data including the user and the item.

2. The method of claim 1, wherein identifying the portion of the model comprising the subset of layers comprising the model comprises:
identifying the portion of the model as a subset of layers of the model within a threshold distance of an output layer of the model.

3. The method of claim 1, wherein the specific interaction with the item comprises including the item in an order.

4. The method of claim 1, wherein the specific interaction with the item comprises selecting a content item corresponding to the item.

5. The method of claim 1, wherein the specific interaction with the item comprises requesting additional information about the item.

6. A computer program product comprising a non-transitory computer readable storage medium having instructions encoded thereon that, when executed by a processor, cause the processor to:
obtain training data including a plurality of examples of items and of users from interactions by users with items displayed to the users in orders based on likelihoods of a user performing a specific interaction with an item generated from a model, an example of the training data including a combination of a user embedding of the user and an item embedding of the item to which a label indicating whether the user performed the specific interaction with the item is applied;
train the model by applying the model to each example of the training data and backpropagating one or more error terms obtained from one or more loss functions through layers of the model, an error term based on a difference between a predicted likelihood of the user performing the specific interaction with the item and a label applied to an example of the training data including the user and the item;
obtain exploration training data including a plurality of exploration examples of items and of users from interactions by users with items displayed to the users in random orders an exploration example of the exploration training data including a combination of the user embedding of the user and the item embedding of the item to which a label indicating whether the user performed the specific interaction with the item is applied;
identify a portion of the model comprising a subset of layers comprising the model; and
training the model by applying the model to each exploration example of the exploration training data and backpropagating one or more error terms obtained from one or more loss functions through layers of the portion of the model while freezing layers not included in the portion of the model, the error term based on a difference between the predicted likelihood of the user performing the specific interaction with the item and a label applied to an exploration example of the exploration training data including the user and the item.

7. The computer program product of claim 6, wherein identify the portion of the model comprising the subset of layers comprising the model comprises:
identify the portion of the model as a subset of layers of the model within a threshold distance of an output layer of the model.

8. The computer program product of claim 6, wherein the specific interaction with the item comprises including the item in an order.

9. The computer program product of claim 6, wherein the specific interaction with the item comprises selecting a content item corresponding to the item.

10. The computer program product of claim 6, wherein the specific interaction with the item comprises requesting additional information about the item.

11. A model generating a likelihood of performing a specific interaction with an item stored on a non-transitory computer readable storage medium, the model produced by:
obtaining training data including a plurality of examples of items and of users from interactions by users with items displayed to the users in orders based on likelihoods of a user performing the specific interaction with the item generated from the model, an example of the training data including a combination of a user embedding of the user and an item embedding of the item to which a label indicating whether the user performed the specific interaction with the item is applied;
training the model by applying the model to each example of the training data and backpropagating one or more error terms obtained from one or more loss functions through layers of the model, an error term based on a difference between a predicted likelihood of the user performing the specific interaction with the item and a label applied to an example of the training data including the user and the item;
obtaining exploration training data including a plurality of exploration examples of items and of users from interactions by users with items displayed to the users in random orders an exploration example of the exploration training data including a combination of the user embedding of the user and the item embedding of the item to which a label indicating whether the user performed the specific interaction with the item is applied;
identifying a portion of the model comprising a subset of layers comprising the model; and
training the model by applying the model to each exploration example of the exploration training data and backpropagating one or more error terms obtained from one or more loss functions through layers of the portion of the model while freezing layers not included in the portion of the model, the error term based on a difference between the predicted likelihood of the user performing the specific interaction with the item and a label applied to an exploration example of the exploration training data including the user and the item.

12. The model of claim 11, wherein identifying the portion of the model comprising the subset of layers comprising the model comprises:
identifying the portion of the model as a subset of layers of the model within a threshold distance of an output layer of the model.

13. The model of claim 11, wherein the specific interaction with the item comprises including the item in an order.

14. The model of claim 11, wherein the specific interaction with the item comprises selecting a content item corresponding to the item.

15. The model of claim 11, wherein the specific interaction with the item comprises requesting additional information about the item.
